(19) United States
(12) Patent Application Publication
(10) Pub. No.: US 2007/0136162 A1
(43) Pub. Date: Jun. 14, 2007

(54) Methods and systems for providing a purchase package for a vehicle

(75) Inventors: Steven Robert Thibodeau, Carrollton, TX (US); Ryan Brooks Bell, Plano, TX (US); Mark David Matz, Allen, TX (US); Daniel Raymond Swanson SR., Midlothian, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/298,602

(22) Filed: Dec. 12, 2005

(51) Int. Cl. G06Q 40/00

(52) U.S. Cl. 705/35; 705/38

(57) ABSTRACT

Systems and methods are disclosed for providing a purchase package for a vehicle. In one embodiment, a method is disclosed that includes receiving, at a financial account provider, information associated with a purchase package for a purchase transaction between a first merchant and the customer for a vehicle provided by the first merchant. The purchase package may include a first option provided by a second merchant and has at least one attribute that has been negotiated between the first and second merchants prior to the purchase transaction. The purchase package may include a purchase package cost based on at least the at least one attribute and a cost of the vehicle. The method may further include providing, by the financial account provider, a financial account for the customer to finance the purchase package cost.

### DESCRIPTION OF THE INVENTION

1. Field of the Invention

The present invention generally relates to methods and systems for providing financial account-based products, and, more particularly for providing purchase packages associated with a vehicle.

2. Background of the Invention

The process of purchasing vehicles often involves several stages. After selecting a vehicle, a customer may select options associated with the vehicle, such as air conditioning, automatic transmission, and other forms of operational and physical characteristics associated with the vehicle. These options may be added to the purchase price. Further, other types of options may be selected and purchased by the customer, such as warranty plans. The cost of these options may also be added to the vehicle's purchase price. Each of these options may be negotiated between the customer and merchant that result in a final purchase price agreement for the vehicle. Some customers choose to finance the cost of the vehicle through a loan provided by, for example, the merchant selling the vehicle (e.g., a dealer financing plan) or a separate financial account provider (e.g., such as the customer's bank, credit union, and other types of lenders). After settling on a purchase price, the customer may then consider one or more financing options for financing the cost of the purchase price. Typically this includes consideration of financing offers from the merchant, which are generally provided by a back-end financial account provider. Alternatively, the customer may seek financing directly from a financial account provider (e.g., the customer's bank, etc.). Once the customer selects and is approved for financing, the purchase transaction between the customer and merchant is completed, the merchant obtains rights for payment for the vehicle and selected options via the entity financing the vehicle, and the customer takes possession of the purchased vehicle.

In addition to purchasing the vehicle, the customer is also burdened with selecting, maintaining, or purchasing insurance for the vehicle. Generally, the customer already has insurance for a currently owned vehicle when purchasing the new vehicle. In this regard, the customer generally negotiates with their existing insurance provider to purchase new insurance for the purchased vehicle. In most cases, the customer purchases the same type of coverage for the new vehicle (e.g., comprehensive, etc.). In some instances, however the customer may wish to purchase insurance from a different insurance provider. In such instances, the customer may have to research rates offered by competing insurance providers negotiate insurance plan options with a selected provider, and eventually purchases insurance from the selected provider.

Other types of services or products associated with the purchased vehicle may be sought and purchased by the customer. For example, the merchant selling the vehicle may offer service plans that, when purchased by the customer, provide certain pre-paid periodic maintenance services for the vehicle, such as oil changes, tire rotations, periodic check ups, etc. These may be purchased by the customer separately from the purchase transaction of the vehicle, or may be included in the purchase price, depending on the merchant and the financing options available to the customer.

Accordingly, customers typically make multiple decisions when purchasing a vehicle, each of which may result in a different bill being generated. For instance, the customer may receive a first bill from a financial account provider that provided financing for the purchased vehicle. The customer may also receive a second bill from an insurance provider providing insurance for the purchased vehicle. Additionally, the merchant may send the customer a bill for any service options purchased by the customer that was not included in the financed purchase price. Therefore, the purchase of a single vehicle results in the consideration, processing, and managing of several financial accounts with different business entities.

Accordingly, there is a need for a method and system that provides a purchase package that reduces the number of business entities and financial accounts associated with a purchased vehicle.

### SUMMARY OF THE INVENTION

Consistent with embodiments of the present invention, systems and methods are disclosed for providing financial loan arrangements for an item of property.

In accordance with one embodiment, a method is disclosed that includes receiving, at a financial account provider, information associated with a purchase package for a purchase transaction between a first merchant and the customer for a vehicle provided by the first merchant. The purchase package may include a first option provided by a second merchant and has at least one attribute that has been negotiated between the first and second merchants prior to the purchase transaction. The purchase package may include a purchase package cost based on at least the at least one attribute and a cost of the vehicle. The method may further include providing, by the financial account provider, a financial account for the customer to finance the purchase package cost.

According to another embodiment, a system for providing a purchase package for a vehicle is disclosed. The system may include a computer system associated with a financial account provider that is configured to receive information associated with a purchase package for a purchase transaction between a first merchant and the customer for a vehicle provided by the first merchant. The purchase package may include a first option provided by a second merchant and includes at least one attribute that has been negotiated between the first and second merchants prior to the purchase transaction. The purchase package may also include a purchase package cost based on at least the first option and a cost of the vehicle. The computer system is further configured to provide information reflecting a financial account for the customer that is used to finance the purchase package cost. The system may also include a network connected to the computer system for exchanging information with the computer system and at least the first merchant.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary environment consistent with certain embodiments of the present invention;

FIG. 2 is a block diagram of an exemplary memory consistent with certain embodiments of the present invention;

FIG. 3 is a flow chart of an exemplary purchase package process consistent with certain embodiments of the present invention;

FIG. 4 is a block diagram of an exemplary financial account statement consistent with certain embodiments of the present invention;

FIG. 5 is a flow chart of another exemplary purchase package process consistent with certain embodiments of the present invention; and

FIG. 6 is a block diagram of an exemplary purchase package display consistent with certain embodiments of the present invention.

### DETAILED DESCRIPTION

The following detailed description refers to the accompanying drawings. Wherever possible, the same reference numbers are used in the drawings and the following description when referring to the same or similar parts. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Systems and methods consistent with the present invention provide purchase packages to customers associated with a product purchased from a merchant. A product may be any type of product or service provided by a merchant and purchased by a customer. The following disclosure describes purchase transactions associated with a vehicle. However, the disclosed embodiments are not limited to vehicle purchase transactions. A vehicle may be any type of new or used vehicle, such as an automobile, a motorcycle, a truck, marine vehicle, aircraft, and any other type of vehicle that is offered for sale and/or lease by a merchant.

According to certain embodiments, the selling merchant computer system and/or a financial account provider computer system may generate a purchase package for a vehicle selected for purchase by the customer. In one embodiment the purchase package may be generated based on the customer's profile information (e.g., credit status, driving history, preferences, etc.). The purchase package may include data reflecting one or more vehicle related options, such as options related to a physical and/or operational attribute of the vehicle, such as engine size, transmission type, leather seats, etc. The purchase package may also include data reflecting one or more service options for the vehicle, such as prepaid maintenance plans, etc. The purchase package may also include data reflecting one or more part replacement options for the vehicle, such as a plan for covering the cost of certain vehicle parts or fluids. Additionally, the purchase package may include data reflecting one or more available insurance plans for the selected vehicle and customer. Moreover, the purchase package may include data reflecting one or more prepaid fuel plans for the vehicle. The purchase package may include data reflecting the total cost for the purchase package, each selected options included in the package. The purchase package may further include data indicating the amount of a periodic payment that is due by the customer should the purchase package be accepted. According to certain embodiments, the purchase package cost may be financed by the financial account provider, which provides the customer with a single financial account and associated statement for payment by the customer. In this regard, the customer may make a single periodic payment to the financial account provider to cover the costs of the vehicle and any associated options included in the purchase package, such as insurance coverage, maintenance plans, etc.

Accordingly, methods and systems consistent with certain embodiments of the present invention enable the customer to select and receive financing for a purchase package for a vehicle. In one embodiment, a financial account provider creates a financial account for the purchase package based on at least one of, for example, a customer profile, type of vehicle, type of options (e.g., insurance), etc. The customer makes payments toward the financial account and thus receives different types of options for the single periodic payment (e.g., insurance coverage, maintenance coverage, etc.). In another embodiment, as part of the financed purchase package, the customer may receive a financial account product (e.g., prepaid credit card or debit card, etc.) that allows the customer to purchase fuel and/or other products/services for the purchased vehicle. The above exemplary embodiments are not intended to be limiting and other features associated with methods and systems consistent with the disclosed embodiments are described below.

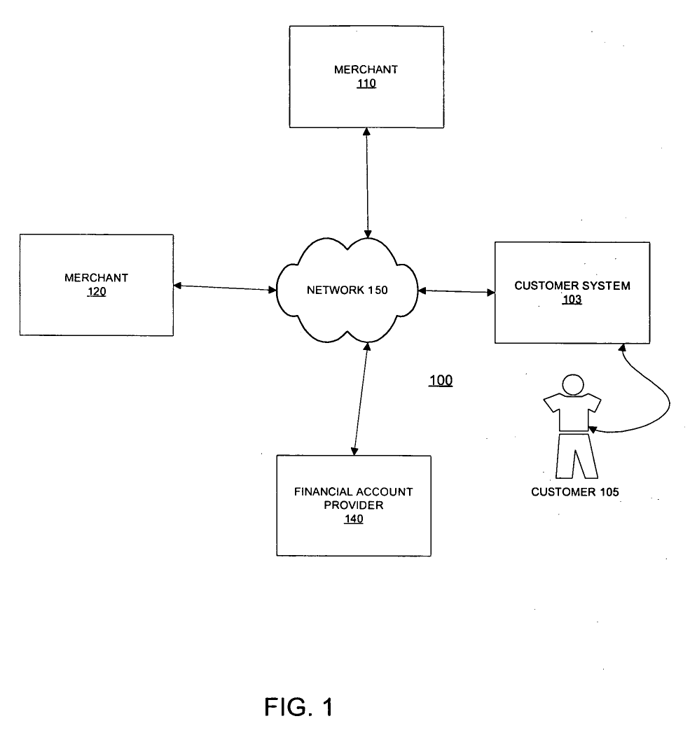

By way of non-limiting examples, FIG. 1 shows a block diagram of an exemplary system environment 100 for implementing embodiments of the present invention. As shown, system environment 100 includes a customer system 103, selling merchant 110, merchants 120, financial account provider 140, and network 150.

Customer system 103 may represent a computer system including one or more processing components used to exchange information with a remotely located computer system (consisting of one or more devices) over a network and perform one or more processes associated with the disclosed embodiments. Customer system 103 may be operated by a customer 105 who is an individual seeking to purchase a vehicle from selling merchant 110. For example, customer system 103 may include a processor that executes a Web browser software program to allow customer 105 to browse Web sites including content reflecting vehicles offered for sale by a merchant, such as selling merchant 110. Alternatively and/or additionally, customer 105 may physically enter a selling merchant's location to purchase a vehicle. For example, customer 105 may use computer system 103 to select and receive from selling merchant 110 purchase package information in accordance with certain disclosed embodiments, and subsequently physically visit the merchant's location to finalize the purchase transaction (e.g., sign documents, take vehicle delivery, etc.).

Selling merchant 110 may be a business entity that sells products and/or services to one or more customers. In one embodiment, selling merchant 110 represents a merchant that sells vehicles. Selling merchant 110 may represent a location that includes the inventory and infrastructure used for selling the vehicles, such as a dealer lot, vehicles for sale, computer systems used by merchant representatives (e.g., salespersons, management, financing personnel, etc.). Selling merchant 110 may also include a computer system that performs software processes consistent with certain disclosed embodiments. For example, selling merchant 110 may manage a Web server that provides one or more Web sites that are accessed by customer 105 via customer system 103. Further, selling merchant 110 may include software that, when executed by a processor, exchanges information with other entities, such as merchant 120 and financial account provider 140 to perform one or more processes consistent with the disclosed embodiments.

In FIG. 1, merchant 120 may correspond to one or more merchants associated with a business entity that provides products or services that may be purchased by another business entity or customer 105. For example, merchant 120 may be associated with an insurance company that provides insurance for vehicles, a vehicle parts vendor that sells parts for vehicles, a maintenance service vendor that sells and performs maintenance services for vehicles, a fuel vendor that sells fuel for vehicles, etc. Merchant 120 may include one or more computers having one or more processors that execute software programs that perform one or more processes consistent with the disclosed embodiments. For example, merchant 120 may include a processor that executes software that exchanges information with selling merchant 110 reflecting one or more options associated with a vehicle provided by merchant 120.

Financial account provider 140 may reflect one or more computers associated with a business entity that provides financial accounts, such as loans, credit card accounts, savings accounts, checking accounts, etc. Financial account provider 140 includes one or more processors that execute software programs that perform one or more processes consistent with the disclosed embodiments. For instance, financial account provider 140 provides one or more financial accounts for customer 105 to purchase a vehicle from selling merchant 110. In one embodiment, financial account provider 140 provides a financial account used by customer 105 to finance a purchase package associated with a vehicle provided by selling merchant 110. In certain embodiments, financial account provider 140 receives data from selling merchant 110 associated with a purchase transaction with customer 105. Based on the received information, financial account provider 140 may create a financial account for the purchase package. In another embodiment, financial account provider 140 may use the received information to generate one or more purchase packages associated with the purchase transaction. Financial account provider 140 may provide data reflecting the created financial account and/or purchase package to selling merchant 110 and/or customer system 103. Alternatively, financial account provider 140 may provide data associated with a financial account to selling merchant 110, which generates the purchase packages for customer 105. Other aspects of the disclosed embodiments are described below and the above examples are not intended to be limiting.

Network 150 is, in one implementation, a communications network that allows components of system environment 100 to exchange information. For example, network 150 may be a communication network such as, for example, the Internet, an Intranet, a Local Area Network (LAN), or any other type of network. Network 150 may include components that enable communications over different types of mediums, such as wired communication mediums (e.g., telephone, Ethernet, fiber optics, etc.) and wireless communication mediums, such as cellular, Bluetooth, microwave, point-to-point wireless, point-to-multipoint wireless, multipoint-to-multipoint wireless, or any other appropriate communication platform for networking a number of components.

Although FIG. 1 shows one merchant 120, embodiments of the present invention may implement one or more merchants 120 that may or may not provide the same type of product or service. For example, system environment 100 may include many insurance provider merchants 120 that provide vehicle insurance that customer 105 may select for a purchase vehicle. As another example, merchant 120 may represent a plurality of merchants that provide parts for vehicles, maintenance services for vehicles, etc. Further, in another embodiment, merchant 120 may be associated with the same business entity as selling merchant 110. For example, merchant 120 may be a franchise service department associated with the business entity of selling merchant 110. Further, system environment 100 may include a plurality of selling merchants 110 that customer 105 may communicate with over network 120 or physically visit. Further, financial account provider 140 may include software that is provided to selling merchant 110 for performing one or more features of the disclosed embodiments.

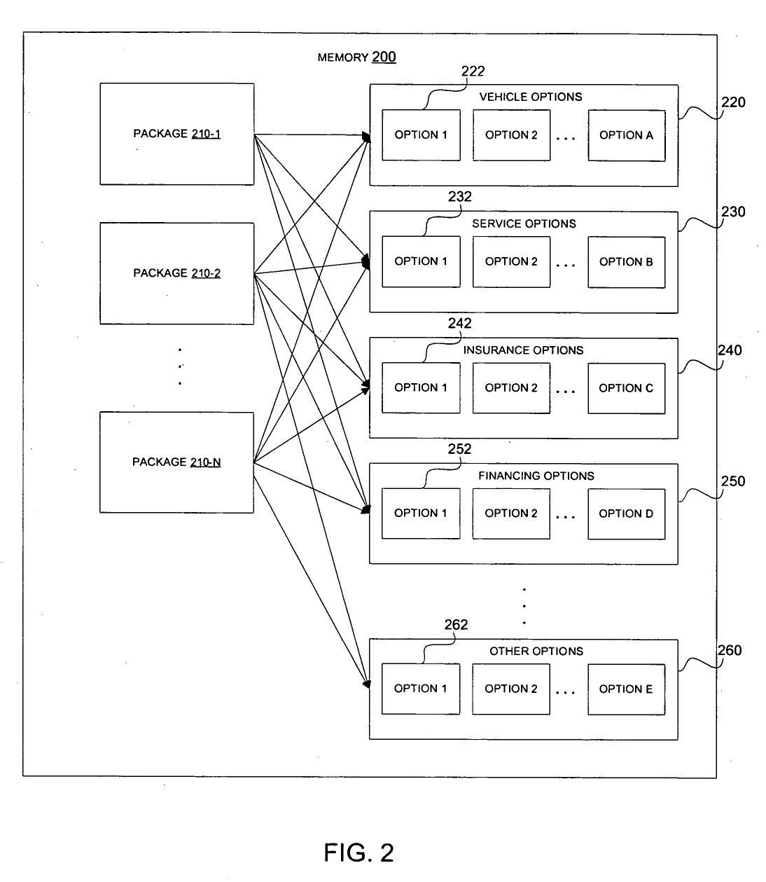

As explained, methods and systems consistent with embodiments of the present invention provide purchase packages for a customer to purchase a product, such as a vehicle. The purchase packages include options that may be purchased along with the product and are affiliated with a financial account provided by financial account provider 140. To illustrate these exemplary embodiments, FIG. 2 shows a memory 200 that includes data reflecting one or more purchase packages 210-1 to 210-N (N being a positive integer) consistent with certain embodiments of the present invention. Memory 200 may be stored in a database accessible by selling merchant 110 and/or financial account provider 140. In one exemplary embodiment, a purchase package (e.g., 210-1) represents a data structure including information associated with a vehicle provided by selling merchant 110 and considered for purchase by customer 105. For example, a purchase package 210-1 to 210-N may include one or more options 220-260 that reflect different types of options that may be purchased along with the vehicle affiliated with the corresponding purchase package. Exemplary purchase package options include vehicle option 220, service options 230, insurance options 240, financing options 250, and other options 260 that may be provided by selling merchant 110 and/or merchant 120. Vehicle options 220 may include one or more options 222 reflecting physical or operation attributes associated with a vehicle, such as air conditioning, type of transmission, type of interior (e.g., cloth or leather seats), and any other type of operational and physical attribute associated with a vehicle. Service options 230 may include one or more options 232 associated with maintenance, warranty, or services that may be performed on a vehicle, such as a maintenance plan that is prepaid for certain types of maintenance service, parts that are covered by a particular warranty plan, etc. The prepaid maintenance plans may include actuarial or “actuarial like” calculations that allow tailoring of the package and package price based on estimated part failure rates. These estimates on parts or part replacements may include data on one or more part, or part component's, Estimated Mean Time Between Failure. These may also include data or estimates on part cost, and/or installation labor costs. For example, a particular model of vehicle may experience periodic part failures. Based on this information, an actuarial based cost of a maintenance option for that vehicle may be determined. Thus, if a certain type of vehicle is known to need a new water pump, for example, every 30,000 miles, (base don historical data associated with this vehicle type), a maintenance plan may offer an option that charges an additional amount for replacement of that given part.

Insurance options 240 include one or more options 242 that are associated with insurance for a vehicle, such as types of coverage (e.g., comprehensive, collision, etc.), deductible information, cost of coverage, and any other information associated with an insurance policy for a vehicle. Financing options 250 may include one or more options 252 associated with a type of financing available for the vehicle, such as length of a vehicle loan, interest rate data, payment period for the loan, etc. Other options 260 may include one or more options 262 associated with any other type of service, attribute, or product associated with a vehicle, such as, for example, a prepaid fuel option, vehicle wash options for obtaining vehicle detailing or cleaning, entertainment options, such as satellite radio plans, automatic alarm message services, navigation services (e.g., GPS services), etc. Accordingly, any one of purchase packages 210-1 to 210-N may include one or more options 220-260 that represent any type of service or product option associated with a vehicle provided by selling merchant 110.

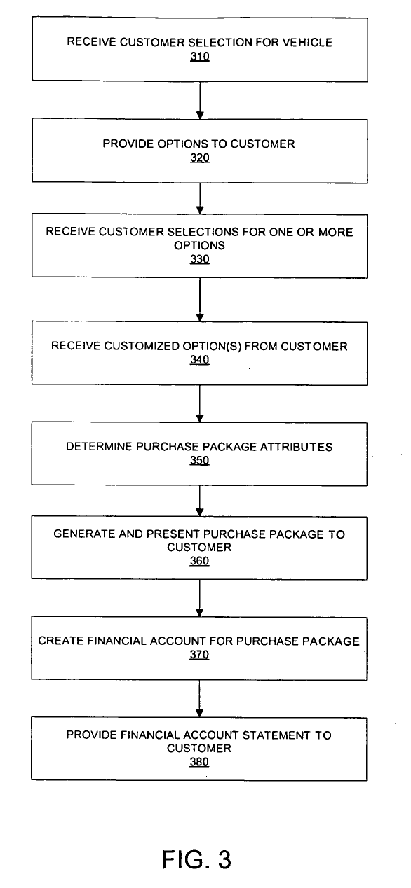

In one embodiment of the present invention, customer 105 may select one or more options associated with a vehicle provided by selling merchant 110 during the purchase transaction for a vehicle. Based on the selected options, selling merchant 110 may generate a purchase package for customer 105 and the vehicle. Further, financial account provider 140 may provide a financial account for financing the cost of the purchase package. The financial account may be affiliated with the customer 105 such that customer 105 may periodically make a single payment toward the single financial account for the vehicle cost and other services and products associated with the vehicle reflected by the selected options within the purchase package. FIG. 3 illustrates a flow chart of an exemplary purchase package process consistent with these disclosed embodiments. Initially, customer 105 contacts selling merchant 110 to select a vehicle for purchase (Step 310). In one embodiment, customer 105 may use customer system 103 to access a Web site provided by selling merchant 110 to review and select a vehicle offered for sale by selling merchant 110. Alternatively, customer 105 may physically visit a site (e.g., dealership) associated with selling merchant 110 to select a vehicle for purchase. In this regard, a merchant representative may receive a vehicle selection from customer 105 at the selling merchant 110 site. In one embodiment, the representative may use a computer system to execute a software process that receives customer 105's selection via an input device, such as a keyboard, mouse, touch screen, voice activated input, downloading a selection from an electronic device, such as a Personal Digital Assistant (PDA), smart card, portable memory device, etc.

In addition to the vehicle selection, selling merchant 110 also provides one or more options (e.g., options 220-260) for consideration by customer 105 (Step 320). In one embodiment, selling merchant 110 may generate messages or content that is displayed to customer 105 via customer system 103 reflecting one or more options available to customer 105, such as vehicle options 220, service options 230, insurance options 240, financing options 250, and other options 260. Alternatively, selling merchant 110 may provide messages or content to customer 105 who is visiting a selling merchant 110 site. For example, customer 105 may review one or more purchase package options for selection via a kiosk, a computer system designated for customers, a computer system operated by merchant representative, and any other type of computer system that may display one or more options to customer 105.

In response, selling merchant 110 receives one or more selections by customer 105 for one or more of the options provided in Step 320 (Step 330). In one embodiment, selling merchant 110 may receive option selections from customer 105 via network 120 and customer system 103. Alternatively, if customer 105 is physically present at a selling merchant 110 site, selling merchant 110 may receive the customer's selections via a local computer system, such as the same computer system used to provide the options to customer 105 (e.g., merchant representative computer system, kiosk, etc.)

In another embodiment, customer 105 may provide customized options to selling merchant 105 for consideration and inclusion in a purchase package (Step 340). A customized option may be an option associated with the selected vehicle that is not offered or provided by selling merchant 110 to customer 105 during the purchase transaction of the selected vehicle. For example, a customized option may be associated with an insurance policy that customer 105 wished to include in the purchase package for the selected vehicle. Selling merchant 110 may determine whether to accept the customized option provided by customer 105. If so, selling merchant 110 includes the customized option as one of the selected options received in Step 330 for inclusion in the purchase package. If selling merchant 110 does not accept the customized option, the option will not be included in the selected options received in Step 330 for inclusion in the purchase package.

Selling merchant 110 may also determine purchase package attributes based on the options selected by customer 105 (Step 350). A purchase package attribute may be data associated with the purchase package for the selected vehicle, such as a cost for a selected option (e.g., vehicle option 232, service option 242, etc.), one or more parameters associated with a selected option (e.g., length of a service plan, types of parts covered by a parts plan, restrictions associated with a particular service plan, warranty plan, etc.), interest rate for a financial account associated with the purchase package, payment period for the financial account, amount of periodic payments for the purchase package, and any other type of information that may be associated a purchase package.

In one embodiment, selling merchant 110 may request information from remote entities to determine a purchase package attribute. For example, selling merchant 110 may request and receive information from an insurance provider associated with the cost and conditions associated with an insurance policy for the vehicle and customer 105. In another example, selling merchant 110 may request and receive approval, terms, and conditions associated with a financial account provided by financial account provider 140 for financing the cost of the purchase package, or portions thereof. In certain embodiments, selling merchant 110 may request and receive information for generating purchase package attributes from a first entity (e.g., merchant 120) and use that received information to request and receive additional information from a second entity (e.g., financial account provider 140). For instance, in order to determine the total cost of a purchase package, selling merchant 110 may first request and receive attribute information from one or more merchants 120. Based on the received attribute information, selling merchant 110 may generate a request for additional attribute information from another merchant 120. For example, selling merchant 110 may request approval of a financial account for financing the cost of the purchase package for customer 105 based on the attribute information received from merchant 120. In certain embodiments, however, selling merchant 110 may not request a financial account from financial account provider 140 until the purchase package is generated, as discussed in the exemplary embodiments described below.

Once the purchase package attributes are determined, selling merchant 110 may generate and present the purchase package for customer 105 and the selected vehicle (Step 360). In one embodiment, selling merchant 110 may provide the purchase package as content on a Web page displayed by customer system 103. Alternatively, selling merchant 110 may provide the purchase package in an electronic mail message sent to customer system 103. In another embodiment, selling merchant 110 may display the purchase package to customer 105 who is physically located at a selling merchant 110 site via a computer system within selling merchant 110, such as a kiosk, merchant representative computer system, etc. Alternatively or additionally, a selling merchant representative may provide a hard copy print out of purchase package to customer 105. Any type of medium or process may be used to present the purchase package to customer 105 depending on the location of customer 105 and the components used to exchange information with selling merchant 110 (e.g., network 120, customer system 103, etc.).

If customer 105 accepts the attributes associated with the provided purchase package, selling merchant 110 may request from financial account provider 140 a financial account for financing the purchase package. Financial account provider 140 may receive the purchase package attributes included in the request from selling merchant 110 to determine whether to approve and create a financial account for the purchase package. In one embodiment, financial account provider 110 may access and process credit history information associated with customer 105 to determine whether to approve customer 105 for such a financial account. If so, financial account provider 140 creates a financial account for the selected purchase package for customer 105 (Step 370). The financial account may be reflected by a data structure within a database managed by financial account provider 140. The data structure may include data fields or parameter information associated with the financial account, such as outstanding balance, interest rate data, periodic payment amount, penalty data, terms and condition data, etc. Financial account provider 140 may send selling merchant 110 this information associated with the created financial account for presentation to customer 105, such as an agreement with terms and conditions, payment information, etc. associated with the financial account. Once executed by customer 105, and the purchase transaction is completed, selling merchant 110 may notify financial account provider 140 via network 150 that the purchase transaction has been completed using the financial account.

Subsequently, financial account provider 140 generates and provides a financial account statement to customer 105 (Step 380). Financial account provider 140 may use contact information collected by selling merchant 110 and provided to financial account provider 140 (e.g., mailing address, email address) to generate and deliver the financial account statement to customer 105. Alternatively, customer 105 may access a Web site associated with financial account provider 140 including content reflecting the financial account statement for customer 105. The financial account statement may include information reflecting the purchase package attributes, including, for example, a monthly payment due by customer 105 to financial account provider 140 for the financial account associated with the purchase package. Customer 105 may make payments to financial account provider 140 by any known payment means, such as electronic payments, standard mail mechanisms (e.g., payment by check mailed to financial account provider 140), etc.

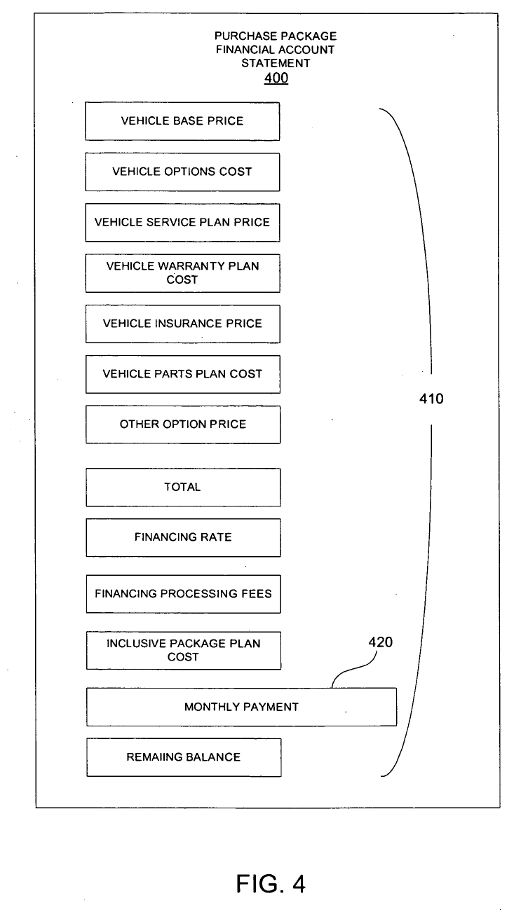

FIG. 4 illustrates a block diagram of an exemplary financial account statement 400 associated with an exemplary purchase package consistent with certain embodiments of the present invention. The configuration of financial account statement 400 is exemplary and not intended to be limiting. Any format and type of information may be included in statement 400 consistent with the disclosed embodiments. Further, financial account statement 400 may reflect data that is provided to customer 105 over network 150. As shown, financial account statement 400 may include purchase package attribute data 410 representing data values associated with the purchase package, such as the cost of the vehicle, the cost of included options, etc. For example, the attribute data 410 may include information reflecting the amount of a periodic payment for the purchase package 420.

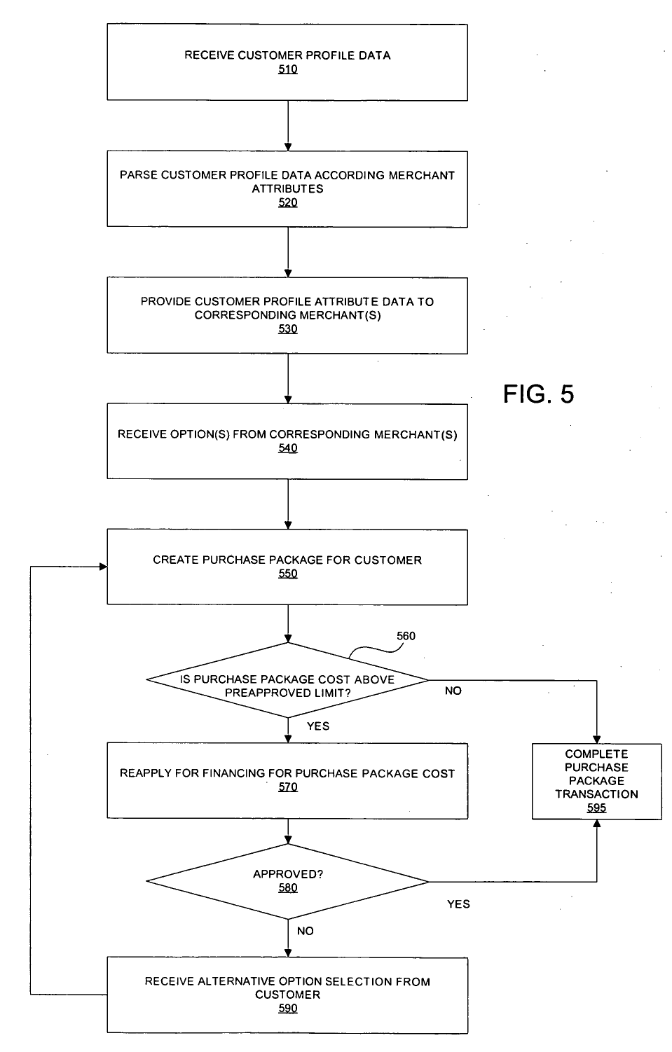

As explained, customer 105 may receive and select a purchase package for a vehicle to be purchased from selling merchant 110. In one embodiment, customer 105 may be associated with customer profile data that includes personal history information such as credit history information (e.g., employment data, contact information, salary, pre-approved offers for vehicle loan from financial account provider 140, insurance policy information for a current vehicle, etc.) Methods and systems consistent with certain embodiments may use the customer profile data to generate a purchase package. FIG. 5 shows a flowchart of another exemplary purchase package process consistent with these certain disclosed embodiments. In one example, selling merchant 105 may receive customer profile data associated with customer 105 (Step 510). Selling merchant 105 may receive the customer profile data over network 150 if customer 105 is accessing selling merchant 110 via customer system 103. Alternatively, customer 105 may provide selling merchant 110 with customer profile data when visiting a selling merchant 110 site. For example, customer 105 may carry a memory device including the customer profile on their person when entering a selling merchant 110 site to purchase a vehicle. For instance, customer 105 may carry a portable memory system (e.g., smart card, PDA, flash memory, cell phone, etc.) including the customer profile data. The portable memory system may include wireless technology (e.g., RF, Bluetooth, etc.) that automatically transfers the customer profile data to a selling merchant computer system when read by a reader device in the communication range of the memory system. Alternatively, customer 105 may present the memory system to a selling merchant 110 computer system or a selling merchant representative for downloading to a computer system (e.g., kiosk or computer system accepting and reading the memory device, such as a flash memory download, smart card reader, etc.).

Once received, selling merchant 110 executes a process that parses the customer profile data according to merchant attributes (Step 520). For example, the customer profile data may include insurance policy information, such as current policy terms and conditions, costs, identification of insurance provider, etc.) As another example, the customer profile data may include credit history information that is parsed and associated with financial account provider 140.

Based on the parsed customer profile data, selling merchant 105 may provide corresponding customer profile data to a respective merchant 120 that provides an option (e.g., products or services) associated with the parsed data (Step 530). In one embodiment, selling merchant 110 may send the customer profile data with a vehicle selection offered by customer 105. For instance, following the above example, selling merchant 110 may collect and send an insurance provider the insurance policy information associated with customer 105. As another example, selling merchant 110 may send vehicle selection data to one or more merchants 120 that provide parts for the type of vehicle selected by customer 105.

Based on the received information from selling merchant 110, each merchant 120 may execute software that determines one or more options that it may offer for the vehicle selected by customer 105 based on the customer profile data. Each merchant 120 may then provide to selling merchant 110 data reflecting the one or more options that the merchant 120 offers to be included in the purchase package (Step 540). Based on the merchant 120 options, selling merchant 110 may generate and provide a purchase package for customer 105 and the selected vehicle (Step 550).

Optionally, selling merchant 110 may perform additional steps based on the customer profile data. For instance, as noted above, the customer profile data may include pre-approval information for a vehicle loan offered by financial account. As such, selling merchant 110 determines whether the cost of the purchase package exceeds the limit of the pre-approved loan for customer 105 (Step 560). In another embodiment, selling merchant 110 may send the request for financing the purchase package to financial account provider 140 that determines whether the cost of the purchase package exceeds the limit of the pre-approved loan for customer 105. If the purchase package cost exceeds the pre-approved loan amount (Step 560; Yes), via customer 105's approval, selling merchant 110 may send a request to financial account provider 140 to reapply for a financial account to cover the cost of the purchase package (Step 570). If financial account provider 140 does not approve the new request (Step 580; No), selling merchant 110 may offer and receive from customer 105 revised selections of options for the selected vehicle to reduce the cost of the purchase package (Step 590). This process may include selling merchant 110 generating a request that is sent to the one or more merchants 120 to create updated options based on the new selections by customer 105 (e.g., higher deductible for insurance to lower the cost of the insurance policy, removing vehicle options, etc.). Each merchant 120 may send selling merchant 110 new one or more options for the vehicle in response to the updated selections by customer 105. Based on the alternative option selections, selling merchant 110 create another purchase package for the customer (Step 550). At customer 105's or selling merchant 110's discretion, the process may end if financial account provider 140 does not approve and provide a financial account for customer 105 after a certain number of attempts by selling merchant 110.

However, if the cost of the purchase package does not exceed the pre-approved limit for customer 105 (Step 560; No), or it financial account provider 140 approves the new financial account request (Step 580; Yes), a financial account is created by financial account provider 140, and selling merchant 110 and customer 105 completes the purchase transaction for the selected vehicle based on the selected purchase package and the financial account (Step 595).

In accordance with certain embodiments, methods and systems consistent with certain embodiments of the present invention may provide predetermined purchase packages to customer 105 based on the customer's profile data. For example, selling merchant 110 may receive customer profile data in a manner consistent with that described above in connection with Step 510 of FIG. 5. Further, selling merchant 110 may parse the customer profile data and provide the appropriate profile attribute data to corresponding merchants 120 in a manner consistent with that described above in connection with Steps 520 and 530 of FIG. 5. In this embodiment, however, selling merchant 110 may provide each merchant 120 with a number of different vehicles that may be (or have been) selected by customer 105. In one embodiment, the different vehicles may be identified in the customer profile data provided by customer 105. Based on the different vehicles, merchants 120 may provide selling merchant 110 with one or more available options for each vehicle. Using this received option information, selling merchant 110 may generate different available purchase packages for customer 105 for each different vehicle. Selling merchant 105 may provide the available purchase packages to customer system 103 in the form of content on a Web page or information in a data message communicated via network 150. Alternatively, if customer 105 is visiting a selling merchant 110 site, selling merchant 110 may display the different purchase packages to customer 105 via local computer system (e.g., kiosk, representative computer system, etc.).

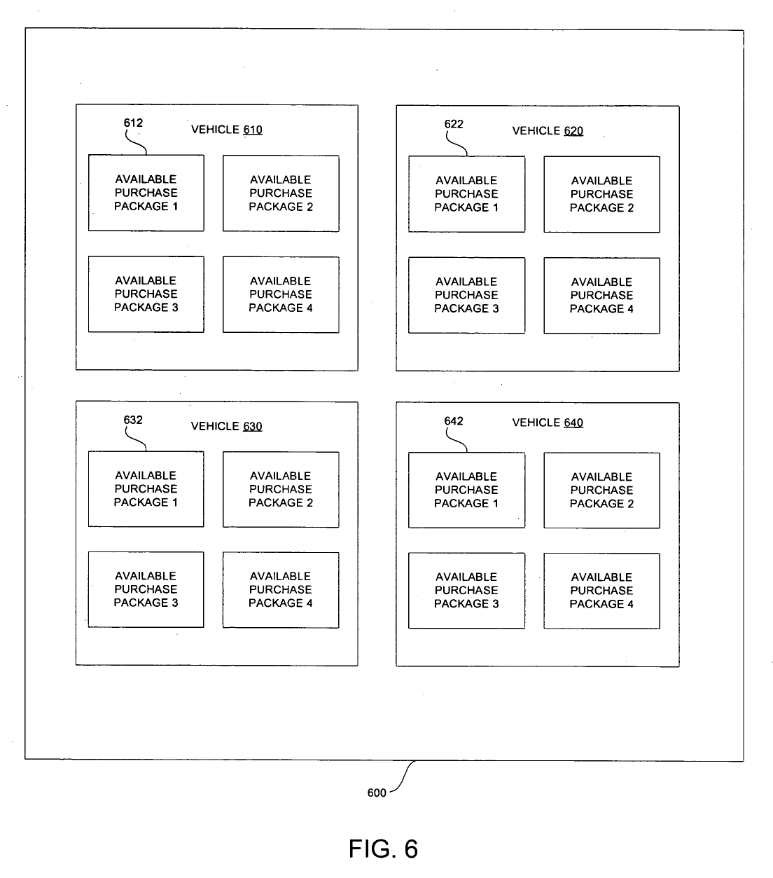

FIG. 6 shows a block diagram of an exemplary display 600 including data reflecting different purchasing packages for a number of exemplary vehicles 610, 620, 630, and 640 that may be selected by customer 105. As shown, each vehicle 610-640 includes corresponding available purchase packages 612, 622, 632, and 642. Accordingly, customer 105 may inspect the options available in each purchase package, as well as the cost of each package and purchase package for different vehicles. Customer 105 may then select a purchase package for a given vehicle based on the attribute information displayed in each purchase package 612, 622, 632, and 642. For instance, a first purchase package for vehicle 610 may include the cost of insurance while a second purchase package for vehicle 610 does not. The total cost of the purchase packages are displayed to allow customer 105 to make a selection based on the amount of financing required for a given package. Display 600 is exemplary and not intended to be limiting. Methods and systems consistent with the disclosed embodiments may include any type of information associated with available purchase packages for given vehicles to provide customer 105 with information for selecting a given package.

In another embodiment, selling merchant 110, or another entity representing the interests of selling merchant 110, may negotiate pre-packaged deals with one or more merchants 120 to provide a service associated with a vehicle provided by selling merchant 110. For instance, selling merchant 110 may negotiate with one or more insurance companies to provide an insurance package option for a particular type of vehicle and a specified period of time. The negotiation with an insurance company may allow merchant 110 to receive a reduced rate for insurance coverage for the vehicle or a set of vehicles. The insurance coverage may be a certain level of insurance (e.g., liability, comprehensive, etc.). Further, the negotiated cost of the insurance options may be based on a template profile for certain types of customers. For example, the insurance company and merchant 110 may negotiate prices for a type of insurance for a first type of vehicle for a first group of customers that meet certain profile criteria, such as an age range, driving record statistics, employment status, marriage status, etc. Another price may be negotiated for the same first type of vehicle based on a second group of customers having one or more different profile criteria. The negotiated price may also vary based on the type of vehicle. Merchant 110 may negotiate other insurance rates from other insurance companies in a similar manner.

Based on the negotiated costs for the insurance for each type of vehicle, merchant 110 may generate corresponding purchase packages for the vehicles that include the cost of the negotiated insurance. Thus, in this example, a customer may review pre-packaged purchase packages that have a total cost that includes the cost of the pre-negotiated options between merchant 110 and one or more merchants 120 (e.g., insurance company). Merchant 110 may provide different purchase packages for the same vehicle based on the different types of merchants 120 (e.g., different insurance companies). Thus, a customer may review purchase packages for a first vehicle that have respective costs that may vary based on the type of insurance, cost of insurance, and provider of insurance, etc. In another embodiment, the customer may select one or more options (e.g., insurance, repair services, etc.), that have been pre-packaged and negotiated between merchant 110 and one or more merchants 120. Based on the selections, merchant 110 and/or financial account provider 140 may provide a purchase package for a vehicle associated with a purchase transaction.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of embodiments of the invention being indicated by the following claims and their full scope of equivalents. Other embodiments of the invention will be apparent to those skilled in the art from consideration of the specification and practice of the invention disclosed herein. For instance, although the above disclosure describes embodiments of the present invention in connection with a vehicle, methods and systems consistent with the disclosed embodiments may apply the inclusive purchase package features to any type of product or service.

Further, in another embodiment, the purchase package cost may be adjusted dynamically based on the type of one or more options included in the package. For example, customer 105 may finance a purchase package including the cost for vehicle insurance that may change each year as the vehicle depreciates following completion of the purchase transaction. Alternatively, the cost of the insurance may rise based on the driving history of customer 105 or accident history of the vehicle. At the time of the purchase transaction, the cost of the purchase package may reflect a cost associated with a predetermined amount of time for coverage of a given option, which in this example may be insurance coverage. Thus, embodiments of the present invention enable financial account provider 140 to create a financial account that dynamically adjusts it balance and/or periodic payment amount based on adjustments to the cost of one or more options included in the purchase package following the purchase transaction. For example, customer 105 may receive a financial account for a purchase package having a total cost of $20,000 that includes the cost of insurance for the first year at a cost of $2000. At the end of the first year of ownership by customer 105, the insurance cost may fall to $1800 based on the depreciation of the vehicle. As such, financial account provider 140 may adjust the remaining balance and/or periodic payment for the purchase package based on this updated information (which may be received via customer 105, merchant 120, and/or selling merchant 110.) Alternatively, financial account provider 140 and/or selling merchant 110 may allow customer 105 to opt out from paying for future insurance costs for the vehicle via the purchase package. If customer 105 decides to elect this option, financial account provider 140 may adjust the financial account attributes accordingly.

Therefore, it is intended that the specification and examples described herein be considered as exemplary only, with a true scope and spirit of the invention being indicated by the following claims.

What is claimed is:

1. A method for providing a purchase package for a customer, comprising:
receiving, at a financial account provider, information associated with a purchase package for a purchase transaction between a first merchant and the customer for a vehicle provided by the first merchant, the purchase package including a first option provided by a second merchant and having at least one attribute that has been negotiated between the first and second merchants prior to the purchase transaction, the purchase package having a purchase package cost based on at least the at least one attribute and a cost of the vehicle; and
providing, by the financial account provider, a financial account for the customer to finance the purchase package cost.

2. The method of claim 1, wherein the first option was selected by the customer from a set of available options associated with the vehicle that was presented to the customer by the first merchant.

3. The method of claim 1, wherein the first option includes at least one of:
a first option associated with a service that may be performed on the vehicle following completion of the purchase transaction;
a second option associated with a prepaid plan to cover the cost of selected replacement parts for the vehicle;
a third option associated with an insurance policy for the vehicle;
a fourth option associated with a prepaid plan to cover the cost of fuel for the vehicle following completion of the purchase transaction; and
an fifth option associated an entertainment service that provides entertainment data to the vehicle over a wireless connection with the vehicle.

4. The method of claim 1, wherein receiving the purchase package information includes:
receiving a request from the first merchant to finance the vehicle for the customer.

5. The method of claim 4, further including:
determining, by the financial account provider, whether to approve the customer for the financial account based on the request from the first merchant.

6. The method of claim 4, wherein receiving the request includes:
receiving customer profile data from the first merchant including data reflecting a pre-approved loan amount offered to the customer by the financial account provider.

7. The method of claim 6, further including:
determining, by the financial account provider, whether to approve the customer for the financial account based on whether the cost of the purchase package exceeds the pre-approved loan amount.

8. The method of claim 7, further including:
providing, by the financial account provider, a message to the first merchant rejecting the customer for the financial account when the cost of the purchase package exceeds the pre-approved loan amount; and
receiving, by the financial account provider, a second request from the first merchant for re-approval for the financial account to finance the cost of the purchase package.

9. The method of claim 6, wherein the first merchant receives the customer profile data from the customer.

10. The method of claim 1, wherein the first option is an insurance policy for the vehicle.

11. The method of claim 1, further including:
providing, by the financial account provider, an indication to the first merchant indicating that the financial account provider has approved the financial account for the customer to finance the purchase package.

12. The method of claim 1, wherein at least one of the first and second merchants are represented by a respective separate entity and the at least one attribute has been negotiated with the respective separate entity prior to the purchase transaction.

13. The method of claim 1, wherein the purchase package was selected by the customer based on a list of available purchase packages for the vehicle provided by the first merchant to the customer, each available purchase package including at least one option that is provided by a merchant different than the first merchant.

14. A system for providing a purchase package for a customer, comprising:
a computer system associated with a financial account provider that is configured to:
receive information associated with a purchase package for a purchase transaction between a first merchant and the customer for a vehicle provided by the first merchant, the purchase package including a first option provided by a second merchant and includes at least one attribute that has been negotiated between the first and second merchants prior to the purchase transaction, the purchase package having a purchase package cost based on at least the first option and a cost of the vehicle, and
provide information reflecting a financial account for the customer that is used to finance the purchase package cost.
a network connected to the computer system for exchanging information with the computer system and at least the first merchant.

15. The system of claim 14, wherein the first option was selected by the customer from a set of available options associated with the vehicle that was presented to the customer by the first merchant.

16. The system of claim 14, wherein the first option includes at least one of:
a first option associated with a service that may be performed on the vehicle following completion of the purchase transaction;
a second option associated with a prepaid plan to cover the cost of selected replacement parts for the vehicle;
a third option associated with an insurance policy for the vehicle;
a fourth option associated with a prepaid plan to cover the cost of fuel for the vehicle following completion of the purchase transaction; and
an fifth option associated an entertainment service that provides entertainment data to the vehicle over a wireless connection with the vehicle.

17. The system of claim 14, wherein the computer system is configured to receive a request from the first merchant to finance the vehicle for the customer.

18. The system of claim 17, wherein the computer system is configured to analyze the request from the first merchant to determine whether to provide information reflecting an indication to approve the customer for the financial account.

19. The system of claim 17, wherein the computer system is configured to receive customer profile data from the first merchant including data reflecting a pre-approved loan amount offered to the customer by the financial account provider.

20. The system of claim 19, wherein the computer system is configured to analyze the customer profile data to determine whether the cost of the purchase package exceeds the pre-approved loan amount.

21. The system of claim 20, wherein the computer system is configured to:
provide a message to the first merchant rejecting the customer for the financial account when the cost of the purchase package exceeds the pre-approved loan amount; and
receive a second request from the first merchant for re-approval for the financial account to finance the cost of the purchase package.

22. The system of claim 19, wherein the first merchant receives the customer profile data from the customer.

23. The system of claim 14, wherein the first option is an insurance policy for the vehicle.

24. The system of claim 14, wherein the computer system is configured to provide an indication to the first merchant indicating that the financial account provider has approved the financial account for the customer to finance the purchase package.

25. The system of claim 14, wherein the purchase package was selected by the customer based on a list of available purchase packages for the vehicle provided by the first merchant to the customer, each available purchase package including at least one option that is provided by a merchant different than the first merchant.

26. The system of claim 14, wherein at least one of the first and second merchants are represented by a respective separate entity and the at least one attribute has been negotiated with the respective separate entity prior to the purchase transaction.

27. A method for providing a purchase package for a customer, comprising:
receiving, at a financial account provider, information associated with a purchase package for a purchase transaction between a first merchant and the customer for a vehicle provided by the first merchant, the purchase package including an insurance policy for the vehicle provided by an insurance company, the insurance policy having an insurance policy rate that has been negotiated between the first and second merchants prior to the purchase transaction, the purchase package having a purchase package cost based on at least the insurance policy rate and a cost of the vehicle; and
providing, by the financial account provider, a financial account for the customer to finance the purchase package cost.

28. A computer-readable medium including instructions for performing, when executed by a processor, a method for providing a purchase package for a customer, the method comprising:
receiving, at a financial account provider, information associated with a purchase package for a purchase transaction between a first merchant and the customer for a vehicle provided by the first merchant, the purchase package including a first option provided by a second merchant and includes at least one attribute that has been negotiated between the first and second merchants prior to the purchase transaction, the purchase package having a purchase package cost based on at least the first option and a cost of the vehicle; and
providing, by the financial account provider, a financial account for the customer to finance the purchase package cost.
